(19) United States
(12) Patent Application Publication
(10) Pub. No.: US 2015/0348437 A1
(43) Pub. Date: Dec. 3, 2015

(54) Method of Teaching Mathematic Facts with a Color Coding System

(71) Applicant: Laura Marie Kasbar, Spokane, WA (US)

(72) Inventor: Laura Marie Kasbar, Spokane, WA (US)

(21) Appl. No.: 14/726,437

(22) Filed: May 29, 2015

Related U.S. Application Data
(60) Provisional application No. 62/004,695, filed on May 29, 2014.

(51) Int. Cl. G09B 19/02; G09B 5/06

(52) U.S. Cl. CPC G09B 19/025; G09B 5/06

(57) ABSTRACT

A method of teaching mathematical facts with a color coding system is implemented through a computing device, where a user account selects a preferred sub-category to initiate the data presentation process. The preferred sub-category can be an addition sub-category, a subtraction sub-category, a multiplication sub-category, and a division sub-category so that the different mathematical facts can be learned through the data presentation process. Once the data presentation process is initiated by the user account, the software audibly and visually outputs data to the user account so that basic mathematical facts can be learned through the computing device.

The current application claims a priority to the U.S. Provisional Patent application Ser. No. 62/004,695 filed on May 29, 2014.

### FIELD OF THE INVENTION

The present invention relates generally to the field of education. More specifically, the present invention is a method that pairs the learning of basic mathematical facts with a color coding system.

### BACKGROUND OF THE INVENTION

Dyslexia is a reading disorder that is believed to affect three to seven percent of the population and is characterized by trouble reading despite normal intelligence. The effects of dyslexia are different for each person and they occur at various degrees. Some of the effects of dyslexia include problems with sounding out words, spelling words, reading quickly, writing words, pronouncing words, reading comprehension, and memorizing math facts. As the effects of dyslexia and the degree to which an individual suffers the effects vary, the treatment of dyslexia often involves adjusting teaching methods in order to cater to each individual's specific needs. It is well established that some people with dyslexia have a difficult time memorizing basic math facts. Even though some existing teaching method try to overcome this problem, those teaching methods have not able to completely and effectively solve the memorizing basic math facts.

Therefore it is the object of the present invention to provide a method that pairs the learning of math facts with a color coding system. By paring colors and numbers together, a richer field for memory is created for children with learning disabilities. This method is particularly helpful with people who have tried to learn math facts in other manners and have not been successful. The present invention also pairs the colors and numbers with animation to more fully illustrate the mathematical concept as well as close up of the mouth to aid in articulation and cross of the auditory and visual fields in the brain. As a result, the present invention is able to drastically decrease the time required to memorize the math facts.

### BRIEF DESCRIPTION OF THE DRAWINGS

FIG. 1 is a basic flow chart illustrating the overall method of the present invention.

FIG. 2 is a basic flow chart illustrating the addition sub-category within the overall method of the present invention.

FIG. 3 is a basic flow chart illustrating the addition stimulation within the overall method of the present invention.

FIG. 4 is a basic flow chart illustrating the first presentation schedule of the subtraction sub-category within the overall method of the present invention.

FIG. 5 is a basic flow chart illustrating the subtraction stimulation within the overall method of the present invention.

FIG. 6 is a basic flow chart illustrating the second presentation schedule of the subtraction sub-category within the overall method of the present invention.

FIG. 7 is a basic flow chart illustrating the third presentation schedule of the subtraction sub-category within the overall method of the present invention.

FIG. 8 is a basic flow chart illustrating the fourth presentation schedule of the subtraction sub-category within the overall method of the present invention.

FIG. 9 is a basic flow chart illustrating the first presentation schedule of the multiplication sub-category within the overall method of the present invention.

FIG. 10 is a basic flow chart illustrating the second presentation schedule of the multiplication sub-category within the overall method of the present invention.

FIG. 11 is a basic flow chart illustrating the fourth presentation schedule of the multiplication sub-category within the overall method of the present invention.

FIG. 12 is a basic flow chart illustrating the third presentation schedule of the multiplication sub-category within the overall method of the present invention.

FIG. 13 is a basic flow chart illustrating the first presentation schedule of the division sub-category within the overall method of the present invention.

FIG. 14 is a basic flow chart illustrating the second presentation schedule of the division sub-category within the overall method of the present invention.

FIG. 15 is a basic flow chart illustrating the fourth presentation schedule of the division sub-category within the overall method of the present invention.

FIG. 16 is a basic flow chart illustrating the third presentation schedule of the division sub-category within the overall method of the present invention.

### DETAIL DESCRIPTIONS OF THE INVENTION

All illustrations of the drawings are for the purpose of describing selected versions of the present invention and are not intended to limit the scope of the present invention.

The present invention provides a method of teaching mathematic facts with a color coding system for children with learning disabilities. The present invention is implemented as a software by executing computer-executable instructions stored on a non-transitory computer-readable medium that can be implemented as a local storage medium, such as a digital video disc (DVD), or a remote storage medium, such as a server used to host a web-based platform. The software of the present invention provides a computing device through which the user can interact with the software and vice versa. The user is able to learn mathematic facts through the present invention as the present invention is stored with a basic mathematic category that includes an addition sub-category, a subtraction sub-category, a multiplication sub-category, and a division sub-category.

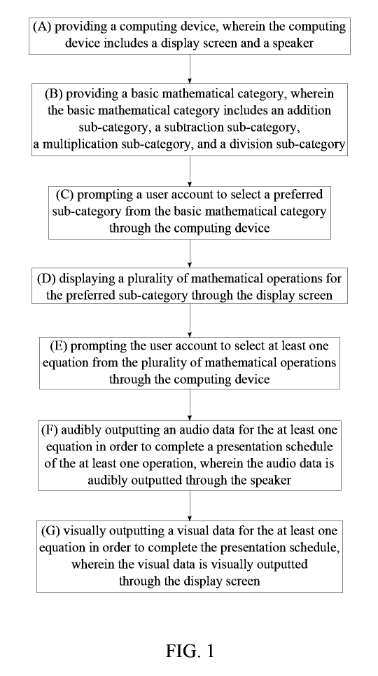

To initiate the present invention as shown in FIG. 1, the software prompts a user account to first select a preferred sub-category from the basic mathematic category. The user account is able to select the preferred sub-category through the computing device upon his or her discretion. Once the user account selects the preferred sub-category, the software displays a plurality of mathematical operations for the preferred sub-category through a display screen of the computing device. For example, if the user account selects the addition sub-category as the preferred sub-category, the software displays a variety of addition equations as the plurality of mathematical operations. Once the plurality of mathematical operations is displayed to the user account through the display screen, the software prompts the user account to select at least one equation from the plurality of mathematical operations by utilizing the computing device. In other words, the user account needs to select the at least one equation so that the present invention can be continued. After the at least one equation is selected by the user account, the software outputs an audio data and a visual data for the at least one equation in order to complete a presentation schedule for the at least one presentation. More specifically, the software audibly outputs the audio data through a speaker of the computing device while the visual data is outputted through the display screen. The presentation schedule controls the displayed information as it can differ upon the preferred sub-category and the at least one equation of the present invention.

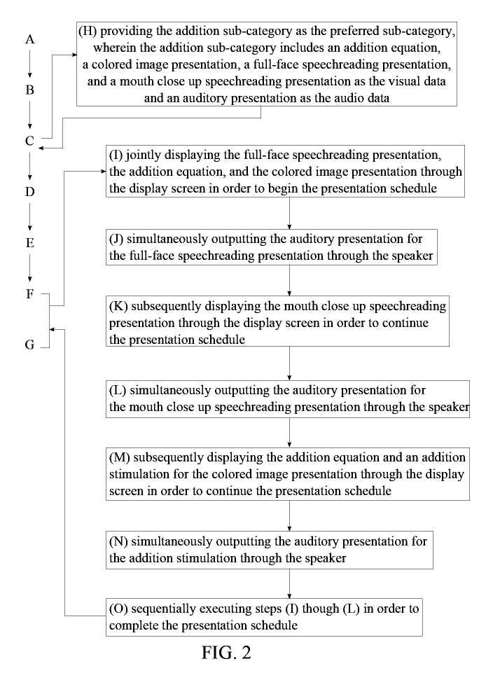

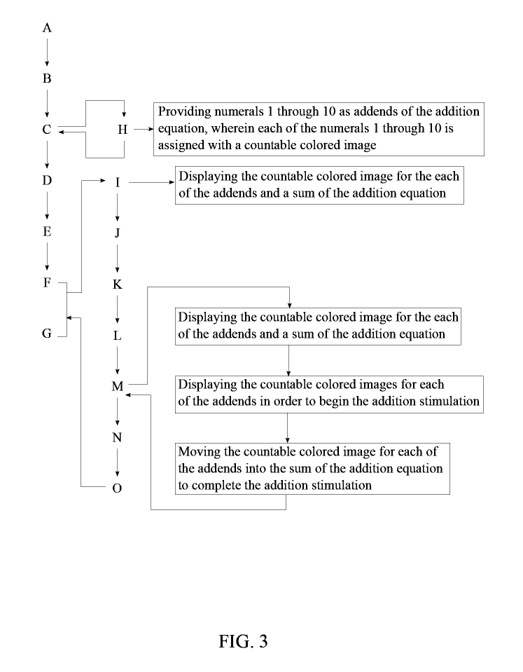

In reference to the selection of the addition sub-category as the preferred sub-category that is shown in FIG. 2 and FIG. 3, the present invention is able to teach basic addition facts to the user account. The software implements a single presentation schedule for the addition sub-category, where the user account is able to learn basic addition facts through the presentation schedule. In order to implement the presentation schedule for the addition sub-category, the addition sub-category includes an addition equation, a colored image presentation, a full-face speechreading presentation, and a mouth close up speechreading presentation as the visual data and an auditory presentation as the audio data.

In order to initiate the presentation schedule, the software jointly displays the full-face speechreading presentation, the addition equation, and the colored image presentation through the display screen while the auditory presentation for the full-face speechreading presentation is outputted through the speaker. In other words, the addition equation and the colored image presentation are continuously displayed through the display screen until the full-face speechreading presentation and the auditory presentation are completed. More specifically, a basic addition fact is displayed as the addition equation while the colored image presentation displays a plurality of countable colored images depicting each numeral of the addition equation. In order to clearly differentiate each numerals of the addition equation, each of the numerals 1 through 10 for addends of the addition equation is assigned with a countable colored image. A sum of the addition equation is also displayed with a single countable colored image that represents combination of countable colored images from the addends. The full-face speechreading presentation demonstrates how a person would deliver the auditory presentation within the present invention in addition to the viewing of the addition equation and the colored image presentation.

Then the mouth close up speechreading presentation is displayed through the display screen with the simultaneous outputting of the auditory presentation for the mouth close up speechreading presentation through the speaker. More specifically, the mouth close up speechreading presentation displays the movements of the mouth in relation to the auditory presentation so that the user account can easily learn how to speak by imitating the mouth close up speechreading presentation.

Then the addition equation is displayed once again with an addition stimulation of the colored image presentation through the display screen while the auditory presentation for the addition stimulation is outputted through the speaker. The addition stimulation demonstrate how the countable colored images for the addends of the addition equation create the countable colored image for the sum of the addition equation. In order to begin the addition stimulation, the countable colored images for each of the addends are initially displayed to the left side of the display screen without showing the countable colored image for the sum. Then the software moves the countable colored images for each of the addends into the right side of the screen. As a result, the countable colored image for the sum is formed and displayed through the display screen, completing the addition stimulation.

After the addition stimulation, the software once again displays the full-face speechreading presentation, the addition equation, and the colored image presentation through the display screen while the auditory presentation for the full-face speechreading presentation is outputted through the speaker. Then the software once again displays the mouth close up speechreading presentation through the display screen with the simultaneous outputting of the auditory presentation for the mouth close up speechreading presentation through the speaker in order to complete the presentation schedule of the addition sub-category.

In reference to the selection of the subtraction sub-category as the preferred sub-category, the present invention is able to teach basic subtraction facts to the user account. The software implements multiple presentation schedules for the subtraction sub-category, where the user account is able to learn basic subtraction facts through the multiple presentation schedules. In order to implement the presentation schedules for the subtraction sub-category, the subtraction sub-category includes a colored subtraction equation, a full-face speechreading presentation, and a mouth close up speechreading presentation as the visual data and an auditory presentation as the audio data. In order to clearly differentiate each numerals of the colored subtraction equation, each of the numerals 0 through 9 for a minuend and a subtrahend of the colored subtraction equation is colored with a respective color. In other words, the respective colors for each of the numerals of the colored subtraction equation are displayed to the user account so that the each numerals can be individually identified with reference to the assigned color.

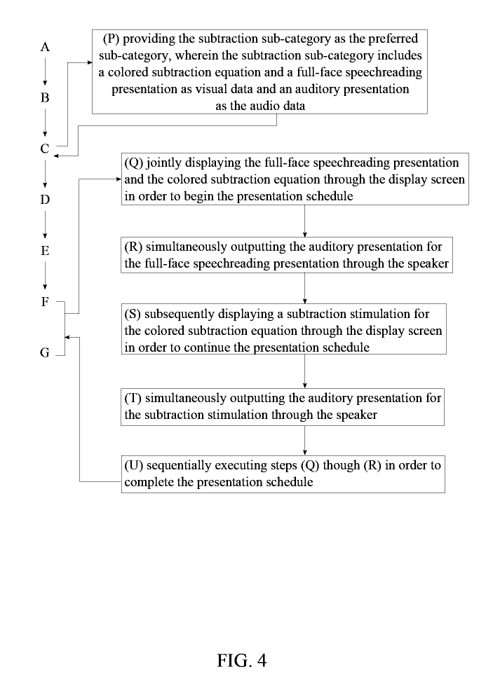

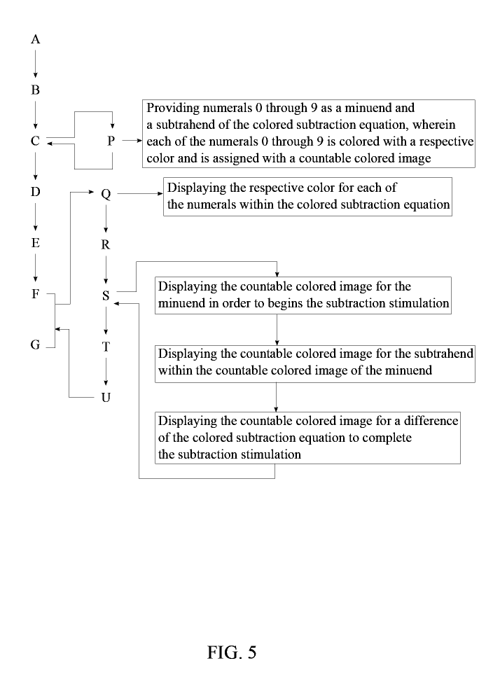

In reference to a first presentation schedule of the subtraction sub-category that is shown in FIG. 4 and FIG. 5, the software jointly displays the full-face speechreading presentation and the colored subtraction equation through the display screen while the auditory presentation for the full-face speechreading presentation is outputted through the speaker. In other words, the colored subtraction equation, which is a basic subtraction fact, is continuously displayed through the display screen until the full-face speechreading presentation and the auditory presentation are completed. The full-face speechreading presentation demonstrates how a person would deliver the auditory presentation within the present invention in addition to the viewing of the colored subtraction equation. Then a subtraction stimulation for the colored subtraction equation is displayed through the display screen while the auditory presentation for the subtraction stimulation is outputted through the speaker. In order to process the subtraction stimulation, each of the numerals 0 through 9 is assigned with a countable colored image that matches with the respective color. The subtraction stimulation demonstrate how the countable colored images for the minuend and the subtrahend of the colored subtraction equation create the countable colored image for a difference of the colored subtraction equation. In order to begin the subtraction stimulation, only the countable colored image for the minuend is initially displayed through the display screen. Then the software displays the countable colored images for the subtrahend with the countable colored image of the minuend. As a result, the user account is clearly able to see difference between the minuend and the subtrahend with respect to the countable colored images. As the final step, the software displays the countable colored image for the difference of the colored subtraction equation through the display screen. After the subtraction stimulation, the software once again displays the full-face speechreading presentation and the colored subtraction equation through the display screen while the auditory presentation for the full-face speechreading presentation is outputted through the speaker in order to complete the first presentation schedule of the subtraction sub-category.

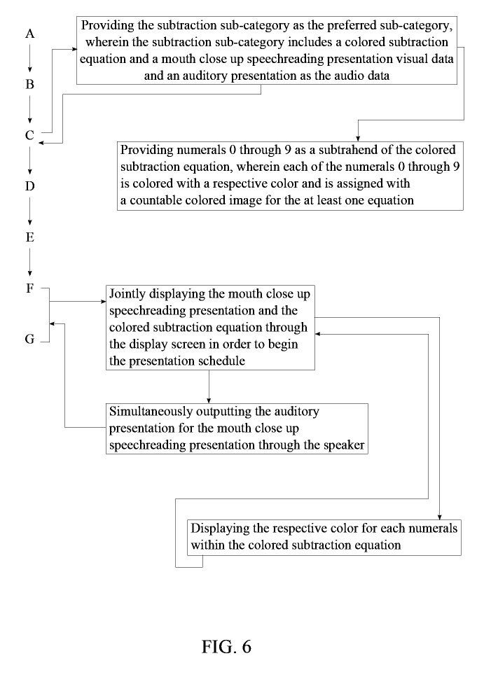

In reference to a second presentation schedule of the subtraction sub-category that is shown in FIG. 6, the software jointly displays the mouth close up speechreading presentation and the colored subtraction equation through the display screen while the auditory presentation for the mouth close up speechreading presentation is outputted through the speaker. In other words, the colored subtraction equation, which is a basic subtraction fact, is continuously displayed through the display screen until the mouth close up speechreading presentation and the auditory presentation are concluded to complete the second presentation schedule of the subtraction sub-category. The mouth close up speechreading presentation displays the movements of the mouth in relation to the auditory presentation so that the user account can easily learn how to speak by imitating the mouth close up speechreading presentation.

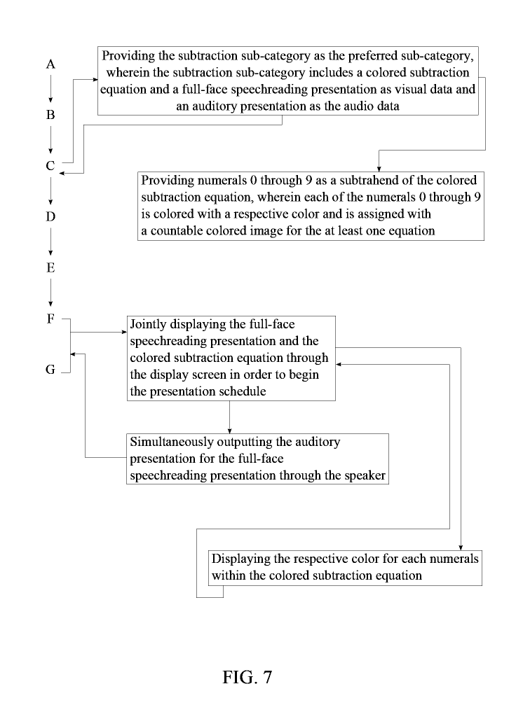

In reference to a third presentation schedule of the subtraction sub-category that is shown in FIG. 7, the software jointly displays the full-face speechreading presentation and the colored subtraction equation through the display screen while the auditory presentation for the full-face speechreading presentation is outputted through the speaker. In other words, the colored subtraction equation, which is a basic subtraction fact, is continuously displayed through the display screen until the full-face speechreading presentation and the auditory presentation are concluded to complete the third presentation schedule of the subtraction sub-category.

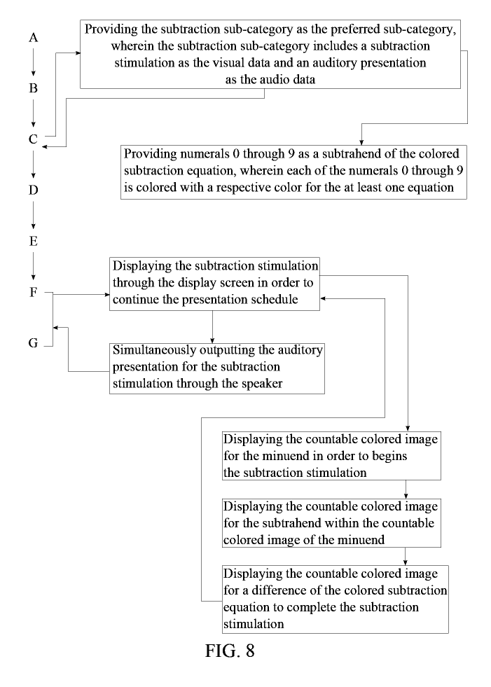

In reference to a fourth presentation schedule of the subtraction sub-category that is shown in FIG. 8, the software displays the subtraction stimulation for the colored subtraction equation through the display screen while the auditory presentation for the subtraction stimulation is outputted through the speaker. In order to process the subtraction stimulation, each of the numerals 0 through 9 is assigned with the countable colored image that matches with the respective color. The subtraction stimulation demonstrate how the countable colored images for the minuend and the subtrahend of the colored subtraction equation create the countable colored image for the difference of the colored subtraction equation. In order to begin the subtraction stimulation, only the countable colored image for the minuend is initially displayed through the display screen. Then the software displays the countable colored images for the subtrahend with the countable colored image of the minuend. As a result, the user account is clearly able to see difference between the minuend and the subtrahend with respect to the countable colored images. As the final step, the software displays the countable colored image for the difference of the colored subtraction equation through the display screen to complete the fourth presentation schedule of the subtraction sub-category

In reference to the selection of the multiplication sub-category as the preferred sub-category, the present invention is able to teach basic multiplication facts to the user account. The software implements multiple presentation schedules for the multiplication sub-category, where the user account is able to learn basic multiplication facts through the multiple presentation schedules. In order to implement the presentation schedules for the multiplication sub-category, the multiplication sub-category includes a colored multiplication equation, a full-face speechreading presentation, and a mouth close up speechreading presentation as the visual data and an auditory presentation as the audio data. In order to clearly differentiate each numerals of the colored multiplication equation, each of the numerals 0 through 9 for the colored multiplication equation is colored with a respective color. In other words, the respective colors for each of the numerals of the colored multiplication equation are displayed to the user account so that the each numerals can be individually identified with reference to the assigned color.

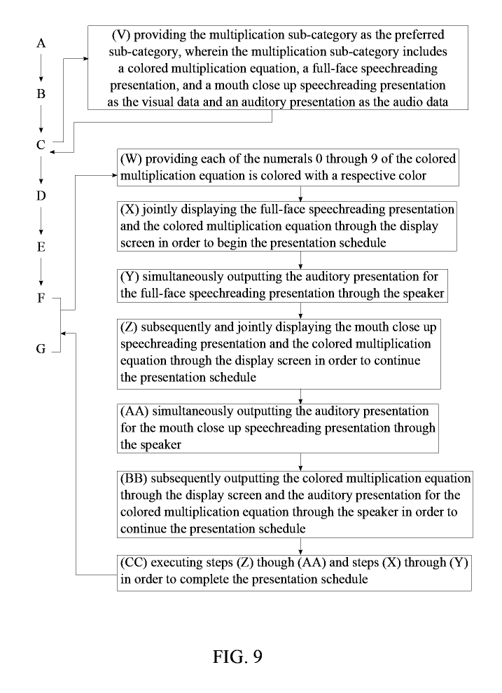

In reference to a first presentation schedule of the multiplication sub-category that is shown in FIG. 9, the software jointly displays the full-face speechreading presentation and the colored multiplication equation through the display screen while the auditory presentation for the full-face speechreading presentation is outputted through the speaker. In other words, the colored multiplication equation, which is a basic multiplication fact, is continuously displayed through the display screen until the full-face speechreading presentation and the auditory presentation are completed. The full-face speechreading presentation demonstrates how a person would deliver the auditory presentation within the present invention in addition to the viewing of the colored multiplication equation. Then the software jointly displays the mouth close up speechreading presentation and the colored multiplication equation through the display screen while the auditory presentation for the mouth close up speechreading presentation is outputted through the speaker. The mouth close up speechreading presentation displays the movements of the mouth in relation to the auditory presentation so that the user account can easily learn how to speak by imitating the mouth close up speechreading presentation.

The colored multiplication equation is then displayed to the user account through the display screen, and the auditory presentation for the colored multiplication equation is outputted through the speaker so that the present invention is able to continue the first presentation schedule.

After the displaying of the colored multiplication equation, the software once again display the mouth close up speechreading presentation and the colored multiplication equation through the display screen while the auditory presentation for the mouth close up speechreading presentation is outputted through the speaker. Then the full-face speechreading presentation and the colored multiplication equation along with the auditory presentation for the full-face speechreading presentation are outputted for the second time so that the first presentation schedule for the multiplication sub-category can be completed.

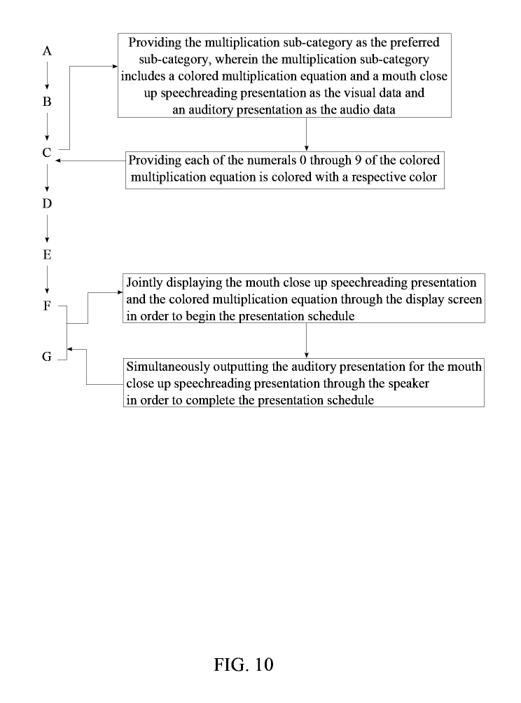

In reference to a second presentation schedule of the multiplication sub-category that is shown in FIG. 10, the software jointly displays the mouth close up speechreading presentation and the colored multiplication equation through the display screen to begin the presentation schedule. Simultaneously, the auditory presentation for the mouth close up speechreading presentation is also outputted through the speaker. Once the mouth close up speechreading presentation and the respective the auditory presentation are completed, the software concludes that the second presentation schedule for the multiplication sub-category is completed.

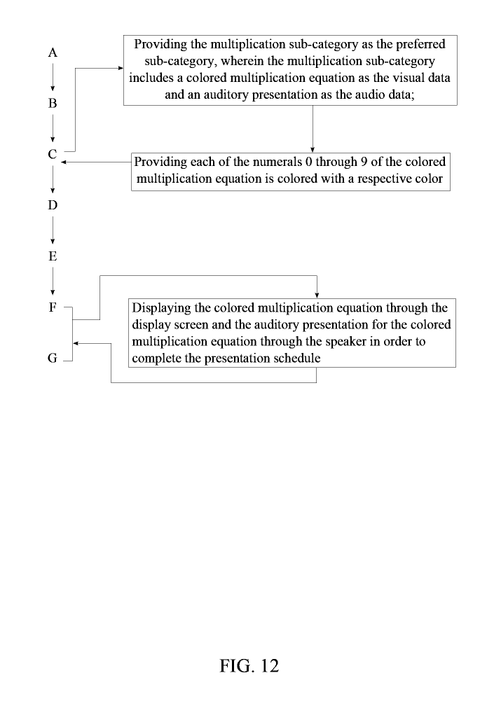

In reference to a third presentation schedule of the multiplication sub-category that is shown in FIG. 12, the software only displays the colored multiplication equation to the user account through the display screen while the auditory presentation for the colored multiplication equation is outputted through the speaker. Once the colored multiplication equation and the respective the auditory presentation are completed, the software concludes that the third presentation schedule for the multiplication sub-category is completed.

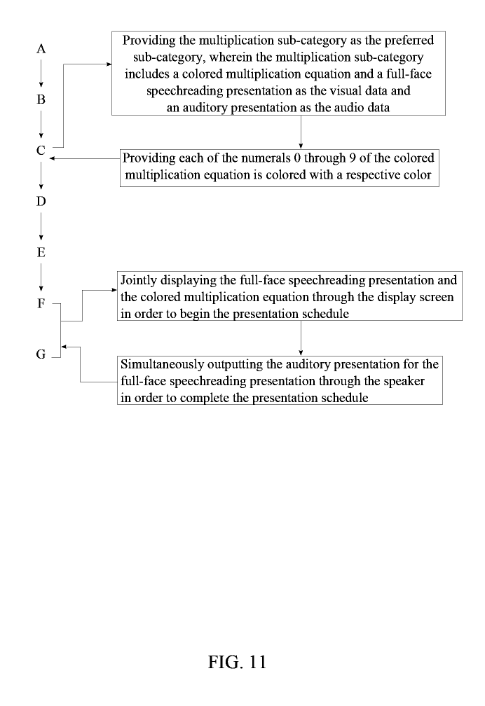

In reference to a fourth presentation schedule of the multiplication sub-category that is shown in FIG. 11, the software only displays the full-face speechreading presentation and the colored multiplication equation through the display screen while the auditory presentation for the full-face speechreading presentation is outputted through the speaker. Once the full-face speechreading presentation, the colored multiplication equation, and the respective the auditory presentation are completed, the software concludes that the fourth presentation schedule for the multiplication sub-category is completed.

In reference to the selection of the division sub-category as the preferred sub-category, the present invention is able to teach basic division facts to the user account. The software implements multiple presentation schedules for the division sub-category, where the user account is able to learn basic division facts through the multiple presentation schedules. In order to implement the presentation schedules for the division sub-category, the division sub-category includes a colored division equation, a full-face speechreading presentation, and a mouth close up speechreading presentation as the visual data and an auditory presentation as the audio data. In order to clearly differentiate each numerals of the colored division equation, each of the numerals 0 through 9 for the colored division equation is colored with a respective color. In other words, the respective colors for each of the numerals of the colored division equation are displayed to the user account so that the each numerals can be individually identified with reference to the assigned color.

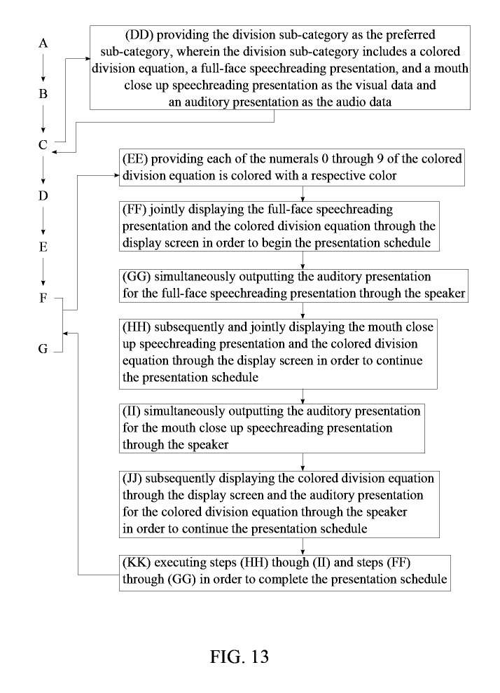

In reference to a first presentation schedule of the division sub-category that is shown in FIG. 13, the software jointly displays the full-face speechreading presentation and the colored division equation through the display screen while the auditory presentation for the full-face speechreading presentation is outputted through the speaker. In other words, the colored division equation, which is a basic division fact, is continuously displayed through the display screen until the full-face speechreading presentation and the auditory presentation are completed. The full-face speechreading presentation demonstrates how a person would deliver the auditory presentation within the present invention in addition to the viewing of the colored division equation.

The software then jointly displays the mouth close up speechreading presentation and the colored division equation through the display screen while the auditory presentation for the mouth close up speechreading presentation is outputted through the speaker. The mouth close up speechreading presentation displays the movements of the mouth in relation to the auditory presentation so that the user account can easily learn how to speak by imitating the mouth close up speechreading presentation.

The colored division equation is then displayed to the user account through the display screen, and the auditory presentation for the colored division equation is outputted through the speaker so that the present invention is able to continue the first presentation schedule.

After the displaying of the colored division equation, the software once again display the mouth close up speechreading presentation and the colored division equation through the display screen while the auditory presentation for the mouth close up speechreading presentation is outputted through the speaker. Then the full-face speechreading presentation and the colored division equation along with the auditory presentation for the full-face speechreading presentation are outputted for the second time so that the first presentation schedule for the division sub-category can be completed.

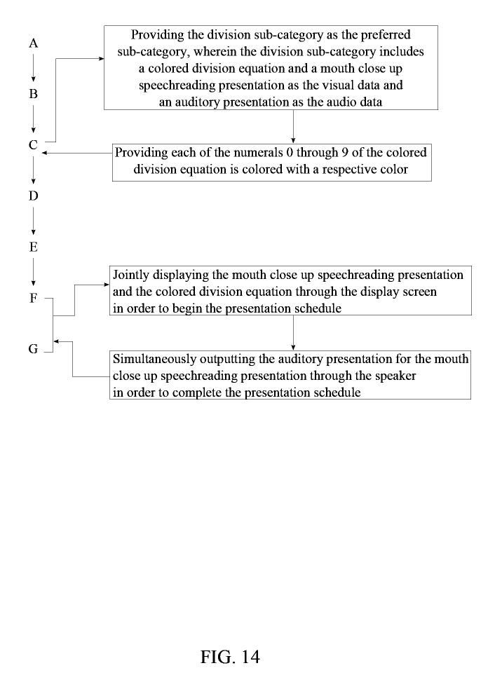

In reference to a second presentation schedule of the division sub-category that is shown in FIG. 14, the software jointly displays the mouth close up speechreading presentation and the colored division equation through the display screen to begin the presentation schedule. Simultaneously, the auditory presentation for the mouth close up speechreading presentation is also outputted through the speaker. Once the mouth close up speechreading presentation and the respective the auditory presentation are completed, the software concludes that the second presentation schedule for the division sub-category is completed.

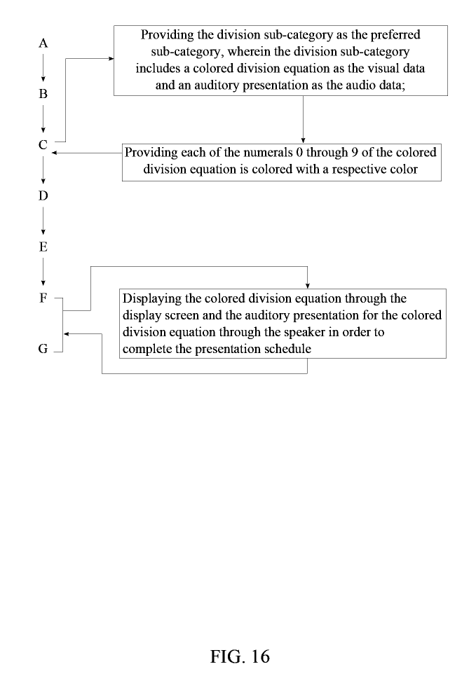

In reference to a third presentation schedule of the division sub-category that is shown in FIG. 16, the software only displays the colored division equation to the user account through the display screen while the auditory presentation for the colored division equation is outputted through the speaker. Once the colored division equation and the respective the auditory presentation are completed, the software concludes that the third presentation schedule for the division sub-category is completed.

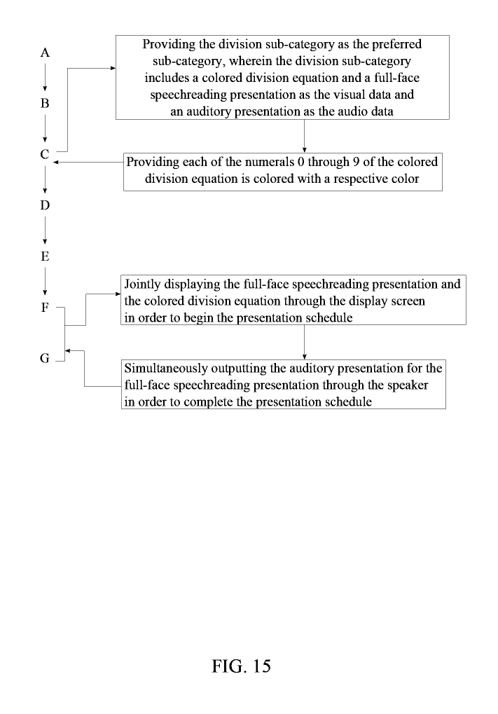

In reference to a fourth presentation schedule of the division sub-category that is shown in FIG. 15, the software only displays the full-face speechreading presentation and the colored division equation through the display screen while the auditory presentation for the full-face speechreading presentation is outputted through the speaker. Once the full-face speechreading presentation, the colored division equation, and the respective the auditory presentation are completed, the software concludes that the fourth presentation schedule for the division sub-category is completed.

Although the invention has been explained in relation to its preferred embodiment, it is to be understood that many other possible modifications and variations can be made without departing from the spirit and scope of the invention as hereinafter claimed.

What is claimed is:

1. A method of teaching mathematic facts with a color coding system by executing computer-executable instructions stored on a non-transitory computer-readable medium, the method comprises the steps of:
(A) providing a computing device, wherein the computing device includes a display screen and a speaker;
(B) providing a basic mathematical category, wherein the basic mathematical category includes an addition sub-category, a subtraction sub-category, a multiplication sub-category, and a division sub-category;
(C) prompting a user account to select a preferred sub-category from the basic mathematical category through the computing device;
(D) displaying a plurality of mathematical operations for the preferred sub-category through the display screen;
(E) prompting the user account to select at least one equation from the plurality of mathematical operations through the computing device;
(F) audibly outputting an audio data for the at least one equation in order to complete a presentation schedule of the at least one operation, wherein the audio data is audibly outputted through the speaker; and
(G) visually outputting a visual data for the at least one equation in order to complete the presentation schedule, wherein the visual data is visually outputted through the display screen.

2. The method of teaching mathematic facts with a color coding system by executing computer-executable instructions stored on a non-transitory computer-readable medium, the method claimed in claim 1 comprises the steps of:
(H) providing the addition sub-category as the preferred sub-category, wherein the addition sub-category includes an addition equation, a colored image presentation, a full-face speechreading presentation, and a mouth close up speechreading presentation as the visual data and an auditory presentation as the audio data;
(I) jointly displaying the full-face speechreading presentation, the addition equation, and the colored image presentation through the display screen in order to begin the presentation schedule;
(J) simultaneously outputting the auditory presentation for the full-face speechreading presentation through the speaker;
(K) subsequently displaying the mouth close up speechreading presentation through the display screen in order to continue the presentation schedule;
(L) simultaneously outputting the auditory presentation for the mouth close up speechreading presentation through the speaker;
(M) subsequently displaying the addition equation and an addition stimulation for the colored image presentation through the display screen in order to continue the presentation schedule;
(N) simultaneously outputting the auditory presentation for the addition stimulation through the speaker; and
(O) sequentially executing steps (I) though (L) in order to complete the presentation schedule.

3. The method of teaching mathematic facts with a color coding system by executing computer-executable instructions stored on a non-transitory computer-readable medium, the method claimed in claim 2 comprises the steps of:
providing numerals 1 through 10 as addends of the addition equation, wherein each of the numerals 1 through 10 is assigned with a countable colored image;
displaying the countable colored image for the each of the addends and a sum of the addition equation;
displaying the countable colored images for each of the addends in order to begin the addition stimulation; and
moving the countable colored image for each of the addends into the sum of the addition equation to complete the addition stimulation.

4. The method of teaching mathematic facts with a color coding system by executing computer-executable instructions stored on a non-transitory computer-readable medium, the method claimed in claim 1 comprises the steps of:
(P) providing the subtraction sub-category as the preferred sub-category, wherein the subtraction sub-category includes a colored subtraction equation and a full-face speechreading presentation as visual data and an auditory presentation as the audio data;
(Q) jointly displaying the full-face speechreading presentation and the colored subtraction equation through the display screen in order to begin the presentation schedule;
(R) simultaneously outputting the auditory presentation for the full-face speechreading presentation through the speaker;
(S) subsequently displaying a subtraction stimulation for the colored subtraction equation through the display screen in order to continue the presentation schedule;
(T) simultaneously outputting the auditory presentation for the subtraction stimulation through the speaker; and
(U) sequentially executing steps (Q) though (R) in order to complete the presentation schedule.

5. The method of teaching mathematic facts with a color coding system by executing computer-executable instructions stored on a non-transitory computer-readable medium, the method claimed in claim 4 comprises the steps of:
providing numerals 0 through 9 as a minuend and a subtrahend of the colored subtraction equation, wherein each of the numerals 0 through 9 is colored with a respective color and is assigned with a countable colored image;
displaying the respective color for each of the numerals within the colored subtraction equation;
displaying the countable colored image for the minuend in order to begins the subtraction stimulation;
displaying the countable colored image for the subtrahend within the countable colored image of the minuend; and
displaying the countable colored image for a difference of the colored subtraction equation to complete the subtraction stimulation.

6. The method of teaching mathematic facts with a color coding system by executing computer-executable instructions stored on a non-transitory computer-readable medium, the method claimed in claim 1 comprises the steps of:
providing the subtraction sub-category as the preferred sub-category, wherein the subtraction sub-category includes a colored subtraction equation and a mouth close up speechreading presentation visual data and an auditory presentation as the audio data;
jointly displaying the mouth close up speechreading presentation and the colored subtraction equation through the display screen in order to begin the presentation schedule; and
simultaneously outputting the auditory presentation for the mouth close up speechreading presentation through the speaker.

7. The method of teaching mathematic facts with a color coding system by executing computer-executable instructions stored on a non-transitory computer-readable medium, the method claimed in claim 6 comprises the steps of:
providing numerals 0 through 9 as a subtrahend of the colored subtraction equation, wherein each of the numerals 0 through 9 is colored with a respective color and is assigned with a countable colored image for the at least one equation; and
displaying the respective color for each numerals within the colored subtraction equation.

8. The method of teaching mathematic facts with a color coding system by executing computer-executable instructions stored on a non-transitory computer-readable medium, the method claimed in claim 1 comprises the steps of:
providing the subtraction sub-category as the preferred sub-category, wherein the subtraction sub-category includes a colored subtraction equation and a full-face speechreading presentation as visual data and an auditory presentation as the audio data;
jointly displaying the full-face speechreading presentation and the colored subtraction equation through the display screen in order to begin the presentation schedule; and
simultaneously outputting the auditory presentation for the full-face speechreading presentation through the speaker.

9. The method of teaching mathematic facts with a color coding system by executing computer-executable instructions stored on a non-transitory computer-readable medium, the method claimed in claim 8 comprises the steps of:
providing numerals 0 through 9 as a subtrahend of the colored subtraction equation, wherein each of the numerals 0 through 9 is colored with a respective color and is assigned with a countable colored image for the at least one equation; and
displaying the respective color for each numerals within the colored subtraction equation.

10. The method of teaching mathematic facts with a color coding system by executing computer-executable instructions stored on a non-transitory computer-readable medium, the method claimed in claim 1 comprises the steps of:
providing the subtraction sub-category as the preferred sub-category, wherein the subtraction sub-category includes a subtraction stimulation as the visual data and an auditory presentation as the audio data;
displaying the subtraction stimulation through the display screen in order to continue the presentation schedule; and
simultaneously outputting the auditory presentation for the subtraction stimulation through the speaker.

11. The method of teaching mathematic facts with a color coding system by executing computer-executable instructions stored on a non-transitory computer-readable medium, the method claimed in claim 10 comprises the steps of:
providing numerals 0 through 9 as a subtrahend of the colored subtraction equation, wherein each of the numerals 0 through 9 is assigned with a countable colored image for the at least one equation;
displaying the countable colored image for the minuend in order to begins the subtraction stimulation;
displaying the countable colored image for the subtrahend within the countable colored image of the minuend; and
displaying the countable colored image for a difference of the colored subtraction equation to complete the subtraction stimulation.

12. The method of teaching mathematic facts with a color coding system by executing computer-executable instructions stored on a non-transitory computer-readable medium, the method claimed in claim 1 comprises the steps of:
(V) providing the multiplication sub-category as the preferred sub-category, wherein the multiplication sub-category includes a colored multiplication equation, a full-face speechreading presentation, and a mouth close up speechreading presentation as the visual data and an auditory presentation as the audio data;
(W) providing each of the numerals 0 through 9 of the colored multiplication equation is colored with a respective color;
(X) jointly displaying the full-face speechreading presentation and the colored multiplication equation through the display screen in order to begin the presentation schedule;
(Y) simultaneously outputting the auditory presentation for the full-face speechreading presentation through the speaker;
(Z) subsequently and jointly displaying the mouth close up speechreading presentation and the colored multiplication equation through the display screen in order to continue the presentation schedule;
(AA) simultaneously outputting the auditory presentation for the mouth close up speechreading presentation through the speaker;
(BB) subsequently outputting the colored multiplication equation through the display screen and the auditory presentation for the colored multiplication equation through the speaker in order to continue the presentation schedule; and
(CC) executing steps (Z) though (AA) and steps (X) through (Y) in order to complete the presentation schedule.

13. The method of teaching mathematic facts with a color coding system by executing computer-executable instructions stored on a non-transitory computer-readable medium, the method claimed in claim 1 comprises the steps of:
providing the multiplication sub-category as the preferred sub-category, wherein the multiplication sub-category includes a colored multiplication equation and a mouth close up speechreading presentation as the visual data and an auditory presentation as the audio data;
providing each of the numerals 0 through 9 of the colored multiplication equation is colored with a respective color;
jointly displaying the mouth close up speechreading presentation and the colored multiplication equation through the display screen in order to begin the presentation schedule; and
simultaneously outputting the auditory presentation for the mouth close up speechreading presentation through the speaker in order to complete the presentation schedule.

14. The method of teaching mathematic facts with a color coding system by executing computer-executable instructions stored on a non-transitory computer-readable medium, the method claimed in claim 1 comprises the steps of:
providing the multiplication sub-category as the preferred sub-category, wherein the multiplication sub-category includes a colored multiplication equation and a full-face speechreading presentation as the visual data and an auditory presentation as the audio data;
providing each of the numerals 0 through 9 of the colored multiplication equation is colored with a respective color;
jointly displaying the full-face speechreading presentation and the colored multiplication equation through the display screen in order to begin the presentation schedule; and
simultaneously outputting the auditory presentation for the full-face speechreading presentation through the speaker in order to complete the presentation schedule.

15. The method of teaching mathematic facts with a color coding system by executing computer-executable instructions stored on a non-transitory computer-readable medium, the method claimed in claim 1 comprises the steps of:
providing the multiplication sub-category as the preferred sub-category, wherein the multiplication sub-category includes a colored multiplication equation as the visual data and an auditory presentation as the audio data;
providing each of the numerals 0 through 9 of the colored multiplication equation is colored with a respective color; and
displaying the colored multiplication equation through the display screen and the auditory presentation for the colored multiplication equation through the speaker in order to complete the presentation schedule.

16. The method of teaching mathematic facts with a color coding system by executing computer-executable instructions stored on a non-transitory computer-readable medium, the method claimed in claim 1 comprises the steps of:
(DD) providing the division sub-category as the preferred sub-category, wherein the division sub-category includes a colored division equation, a full-face speechreading presentation, and a mouth close up speechreading presentation as the visual data and an auditory presentation as the audio data;
(EE) providing each of the numerals 0 through 9 of the colored division equation is colored with a respective color;
(FF) jointly displaying the full-face speechreading presentation and the colored division equation through the display screen in order to begin the presentation schedule;
(GG) simultaneously outputting the auditory presentation for the full-face speechreading presentation through the speaker;
(HH) subsequently and jointly displaying the mouth close up speechreading presentation and the colored division equation through the display screen in order to continue the presentation schedule;
(II) simultaneously outputting the auditory presentation for the mouth close up speechreading presentation through the speaker;
(JJ) subsequently displaying the colored division equation through the display screen and the auditory presentation for the colored division equation through the speaker in order to continue the presentation schedule; and
(KK) executing steps (HH) though (II) and steps (FF) through (GG) in order to complete the presentation schedule.

17. The method of teaching mathematic facts with a color coding system by executing computer-executable instructions stored on a non-transitory computer-readable medium, the method claimed in claim 1 comprises the steps of:
providing the division sub-category as the preferred sub-category, wherein the division sub-category includes a colored division equation and a mouth close up speechreading presentation as the visual data and an auditory presentation as the audio data;
providing each of the numerals 0 through 9 of the colored division equation is colored with a respective color;
jointly displaying the mouth close up speechreading presentation and the colored division equation through the display screen in order to begin the presentation schedule; and
simultaneously outputting the auditory presentation for the mouth close up speechreading presentation through the speaker in order to complete the presentation schedule.

18. The method of teaching mathematic facts with a color coding system by executing computer-executable instructions stored on a non-transitory computer-readable medium, the method claimed in claim 1 comprises the steps of:
providing the division sub-category as the preferred sub-category, wherein the division sub-category includes a colored division equation and a full-face speechreading presentation as the visual data and an auditory presentation as the audio data;
providing each of the numerals 0 through 9 of the colored division equation is colored with a respective color;
jointly displaying the full-face speechreading presentation and the colored division equation through the display screen in order to begin the presentation schedule; and
simultaneously outputting the auditory presentation for the full-face speechreading presentation through the speaker in order to complete the presentation schedule.

19. The method of teaching mathematic facts with a color coding system by executing computer-executable instructions stored on a non-transitory computer-readable medium, the method claimed in claim 1 comprises the steps of:
providing the division sub-category as the preferred sub-category, wherein the division sub-category includes a colored division equation as the visual data and an auditory presentation as the audio data;
providing each of the numerals 0 through 9 of the colored division equation is colored with a respective color; and
displaying the colored division equation through the display screen and the auditory presentation for the colored division equation through the speaker in order to complete the presentation schedule.
